(19) United States
(12) Patent Application Publication
(10) Pub. No.: US 2025/0129309 A1
(43) Pub. Date: Apr. 24, 2025

(54) COLOR CHANGING FALLOUT REMOVER COMPOSITION AND USES THEREOF

(71) Applicant: Illinois Tool Works Inc., Glenview, IL (US)

(72) Inventors: Marcus Desean Huguley, Glenview, IL (US); Andrew Schirmer, Glenview, IL (US)

(73) Assignee: Illinois Tool Works Inc., Glenview, IL (US)

(21) Appl. No.: 18/886,085

(22) Filed: Sep. 16, 2024

Related U.S. Application Data
(60) Provisional application No. 63/545,017, filed on Oct. 20, 2023.

(51) Int. Cl. C11D 3/34; B08B 3/08; C11D 1/72; C11D 3/00; C11D 3/12; C11D 3/20; C11D 3/33; C11D 3/37

(52) U.S. Cl. CPC C11D 3/3454; B08B 3/08; C11D 1/72; C11D 3/0036; C11D 3/124; C11D 3/2065; C11D 3/2086; C11D 3/33; C11D 3/3472; C11D 3/3765

(57) ABSTRACT

A vehicle exterior surface cleaning composition includes at least one benzenediol A surfactant and a thioglycolate are also present in an aqueous diluent. A method of cleaning a vehicle exterior surface is also provide that includes the composition being applied to a vehicle exterior surface. After sufficient contact time, the composition loosens iron containing debris before removing the composition to clean the surface. The composition changes color upon contact with the iron containing debris to provide a visual signal of contamination. The composition removes iron containing debris with limited odor of hydrogen sulfide or ammonia.

### RELATED APPLICATIONS

This application claims priority benefit of U.S. Provisional Application Ser. No. 63/545,017, filed Oct. 20, 2023; the contents of which are hereby incorporated by reference.

### FIELD OF THE INVENTION

The present invention in general relates to a cleaning a vehicle exterior surface, and more particularly to a cleaning composition that removes iron and indicates such action through a color change.

### BACKGROUND OF THE INVENTION

Vehicle wheels are formed from various metal alloys. These alloys are subject to pitting associated with electrochemical reactions with iron. Protective coatings are regularly applied to inhibit such pitting yet require frequent cleaning to prevent accumulation of damaging debris. By way of example, brake disc particles are composed of resin coated steel and ceramics and are routinely shed onto vehicle tires and wheels producing an adhesive grit that can score a protective coating and bring reaction iron into contact with the wheel alloy and other parts of a vehicle exterior fallout, from rail cars, industry, etc.

A common feature of these surface contaminants is that they tend to be lipophilic and as a result, are not easily removed with soap or even detergents absent mechanical forces. Resort to manual rubbing is both time consuming and can lead to underlying surface marring.

The concept of traditional cleaning detergent is to use surfactants to adhere and encapsulate penetrate the grime and then detach soil from the vehicle exterior surfaces. In these typical cleaning detergent formulations, builders are used to help surfactants remove dirt and enhance surfactant performance on soil removal. Chelating agents are often present to complex metal ions to improve cleaning efficiency. However, the cleaning power is still not strong enough to remove all the dirt when these cleaners are applied and then removed with hose pressure water.

An iron fallout remover is a chemical composition that reacts with iron in the debris to facilitate removal through chelation. A common ingredient in an iron fallout remover thioglycolate. Historically, ammonium thioglycolate in the presence of citric acid reacts with iron to form iron thioglycolate—a substance that is reddish in color and easily delaminated from a surface. While effective in freeing iron containing deposits, thioglycolates are commonly used under conditions that liberate hydrogen sulfide, resulting in an unpleasant odor commonly associated with rotten eggs and ammoniacal solutions of thioglycolate have an unpleasant ammonia odor. Other methods are used to remove iron/chelation. By way of example, oxalic acid chelates iron but without a color change.

Thus, there exists a need for an aqueous vehicle exterior surface cleaning composition that affords a color change in the removal of iron deposits without the unpleasant odor associated with conventional iron removal compositions. There further exists a need for a method of cleaning to retain the appearance and lifetime of a wheel, vehicle exterior, or combination thereof.

### SUMMARY OF THE INVENTION

The present disclosure provides a vehicle exterior surface cleaning composition that includes at least one benzenediol operative herein has the general formula:

RO—(C₆H₂R¹R²)—OH
where R is H, or C₁-C₄ alkyl, C₁-C₄ alkyl alcohol, C₁-C₄ alkyl amine, C₁-C₄ alkyl carboxyl; and R¹ and R² are independently in each occurrence: H, OH, SO₃⁻, PO4³⁻, C₁-C₄ alkyl, C₁-C₄ alkyl alcohol, C₁-C₄ alkyl amine, C₁-C₄ alkyl carboxyl, C₂-C₈ alkyl or alkenyl ester, C₁-C₆ alkyl or alkenyl aldehyde, C₁-C₆ alkyl or alkenyl ketone. A surfactant and optionally thioglycolate are also present. An aqueous diluent making up a remainder of the composition.

A method of cleaning a vehicle exterior surface is also provide that includes the composition being applied to a vehicle exterior surface. After sufficient contact time, the composition loosens iron containing debris before removing the composition to clean the surface. The composition changes color upon contact with the iron containing debris to provide a visual signal of contamination. The composition removes iron containing debris with limited odor of hydrogen sulfide or ammonia.

### DETAILED DESCRIPTION OF THE INVENTION

The present invention has utility as a vehicle exterior surface cleaning composition to remove adhered metal containing particulate from the surface while also providing surfactancy-based cleaning of the target substrate. The inclusion of a benzenediol serves to provide all the functional attributes of an iron fallout remover.

Numerical ranges cited herein are intended to recite not only the end values of such ranges but the individual values encompassed within the range and varying in single units of the last significant figure. By way of example, a range of from 0.1 to 1.0 in arbitrary units according to the present invention also encompasses 0.2, 0.3, 0.4, 0.5, 0.6, 0.7, 0.8, and 0.9; each independently as lower and upper bounding values for the range.

As used herein, a vehicle exterior surface is intended to include wheels, tire rims, body panels, undercarriage, and vehicle exterior trim.

According to embodiments, a vehicle exterior surface cleaning composition includes a benzenediol, a surfactant, a hydrotrope, a wetting agent, a protectant, and a diluent. According to embodiments, the surfactant is present in an amount of 0.1 to 8.0 total weight percent, the hydrotrope is present in an amount of 0.1 to 3.0 total weight percent, the wetting agent is present in an amount of 0.1 to 5.0 total weight percent, the protectant is present in an amount of 0.01 to 17 total weight percent, and the diluent is present in an amount that constitutes a remainder of the composition, such that the amounts of all elements of the vehicle exterior surface cleaning composition total 100 percent.

A benzenediol operative herein has the general formula:

RO—(C₆H₂R¹R²)—OH
where R is H, or C₁-C₄ alkyl, C₁-C₄ alkyl alcohol, C₁-C₄ alkyl amine, C₁-C₄ alkyl carboxyl; and R¹ and R² are independently in each occurrence: H, OH, SO₃⁻, PO4³⁻, C₁-C₄ alkyl, C₁-C₄ alkyl alcohol, C₁-C₄ alkyl amine, C₁-C₄ alkyl carboxyl, C₂-C₈ alkyl or alkenyl ester, C₁-C₆ alkyl or alkenyl aldehyde, C₁-C₆ alkyl or alkenyl ketone, or. The variables R, R¹, and R² being without regard to isomeric configuration, alkyl branching, or counterion to charged moieties. Specific benezenediols operative herein include resorcinol, catechol, catecholdisulfonate, guaiacol, 4-methylcatechol, 1,2,4-benzenetriol, 1,2,3-benzenetriol, coniferaldehyde, and. in some inventive embodiments, the benezenediol these are present from 1 to 40 total weight percent of the composition. It is noted that the chelate of iron with benzenediols are brightly colored and illustratively includes red to visually signal to an unaided, normal human eye that iron debris is present on the target substrate. The resulting product has poor adhesion to the target substrate relative to the as-deposited debris. A composition based on a benzenediol affords iron chelation and removal, along with the attributes of detergency and color change indicative of iron chelation.

The surfactant acts as a cleaning agent to boost cleaning of a vehicle exterior surface. According to embodiments, surfactants operative herein are soluble in water, alcohol, and biobased solvent systems. According to embodiments, the surfactant may be selected from a variety of anionic, cationic, non-ionic, and alcohol ethoxylate surfactants. According to embodiments, surfactants operative herein illustratively include nonionic ethoxylated fluorinated surfactants, polyether modified polydimethylsiloxane, polyether modified polymethylalkylsiloxane, aralkyl modified polymethylalkylsiloxane, polyester modified hydroxyl functional polydimethylsiloxane, acryl functional polyester modified polydimethylsiloxane, polyether polyester modified hydroxyl functional polydimethylsiloxane, solution of polyacrylate, solution of a fluoro modified polyacrylate, polymeric fluorinated, ethoxylated alcohol, ethoxylated fatty acid, sorbitan ester, ethoxylated castor oils, alkyl polysaccharides, sorbitan monostearate, sorbitan monolaurate, sorbitan oleate, polyoxyethylene sorbitan, polyoxyethylene sorbitan fatty acid ester, polyoxyethylene sorbitan monooleate surfactants; or anionic phosphonated fluorinated, phosphate ester, aliphatic phosphate ester; or cationic ethoxylated fatty ammonium ethosulphate, ethoxylated alkyl amine; or C₈₋₂₈ alkyl betaine and C₈₋₂₈ alkyl amido betaines; C₈₋₁₆ alkyl polyglycosides; or combinations of any of the aforementioned. Specific non-ionic surfactants operative herein illustratively include lauramidopropylamine oxide, myristamidopropylamine oxide, a mixed lauramidopropylamine and myristamidopropylamine oxide, C₉₋₁₁ ethoxylated alcohols having EO values from 2.5-9, or combinations thereof. In some inventive embodiments, EO 2.5 C₉₋₁₁ ethoxylated alcohol is used in combination with one or more EO 6-9 C₉₋₁₁ ethoxylated alcohols. The ratio of EO 2.5:EO 6-9 C₉₋₁₁ ethoxylated alcohols being between 0.1-1:1. The surfactant is present in an amount of 3 to 32 total weight percent. According to some inventive embodiments, the surfactant is a combination of nonionic linear alcohol ethoxylates present in an amount of 5.0 to 15.0 total weight percent, with other EO containing nonionic surfactants present in an amount of 1.3 to 6.0 total weight percent., and N,N-dimethyl 9-decenamide present in an amount of 0.2 to 1.5 and present in an amount of 0.2 to 0.6 total weight.

Non-ionic surfactants operative herein in some inventive embodiments have hydrophile/lipophile balance (HLB) values between 10 and 20. In some inventive embodiments a mixture of surfactants are present with different HLB values to facilitate removal of a variety of surface contaminants. By way of a example a first surfactant has an HLB value of between 10 and 13, and a second surfactant has an HLB value of between 0 and 20 are present in a weight ratio of 3-33:1.

Thioglycolate is present from 0 to 20 total weight percent without regard to the mass of the counterion. Thioglycolate is illustratively present as an alkali metal or alkali metal salt, ammonium salt, or an acid. The reaction of thioglycolate with iron is well known. E. Lyon. J. Am. Chem. Soc. 1927, 49, 8, 1916-1920. While this reaction can produce a color change indicating the presence of iron, failure to control the reaction conditions yields unpleasant odors of either ammonia or hydrogen sulfide. Without intending to be bound by a particular theory, the benzenediol present in the inventive composition functions to chelate the iron and results in a desired color change without resort of ammonia or the oxidation of thioglycolate to yield hydrogen sulfide. It is appreciated that the benezediol alone is effective in the present invention. Thioglycolate is optionally present in those inventive embodiments in which a catalytic photographic reaction is desired as detailed in JP2003302721.

The protectant provides protection to the clean a vehicle exterior surface against weather elements and stains. According to embodiments, the protectant is a graphene, colloidal silica, amodimethicone, methoxydimethicone, silanes that are liquid at standard temperature and pressure, or a combination thereof. According to embodiments, the protectant may additionally act to prevent corrosion and soiling, to repel water, as a binding agent and as a gloss agent to impart shine to the vehicle exterior surface. As noted above, the protectant is present in an amount of 0 to 5 total weight percent. According to some inventive embodiments, the protectant is a combination of a graphene present in an amount of 0.01 to 0.1 total weight percent.

According to embodiments, the diluent is water as the majority by weight component of the composition with lesser amounts of miscible secondary solvents.

According to embodiments, the vehicle exterior surface cleaning composition additionally includes a solvent, which according to embodiments is present in an amount of 0 to 5.0 total weight percent. according to embodiments, the solvent is a glycol ether solvent, such as diethylene glycol monobutyl ether. The solvent being separate from water that makes up the remainder of the composition.

According to embodiments, the vehicle exterior surface cleaning composition additionally includes a soil capturing agent, which according to embodiments is present in an amount of 0 to 5.0 total weight percent. According to other inventive embodiments is ethylenediamine disuccinic acid (EDDS), ethylenediamine dimalonic acid (EDDM), and ethylenediamine diglutaric acid (EDDG), ethylenediaminetetraacetic acid (EDTA), diethylenetriaminepentaacetic acid (DTPA), nitrilotriacetic acid (NTA), iminodiacetic acid (IDA), iminotriacetic acid (ITA), ethylenediamine (En), N,N′-diethylenediamine (Den), diethylenetriamine (DTN), diethylenetetramine (Trien), triaminotriethylene amine, triethanolamine, malonic acid, succinic acid, glutaric acid, citric acid, fumaric acid, maleic acid, aconitic acid, hydroxyethylethylene diamine triacetic acid (HEDTA), or combinations thereof. Each of the aforementioned is operative herein regardless of the mix of cationic counterions including onium, sodium, potassium, and calcium.

According to some inventive embodiments, the vehicle exterior surface cleaning composition additionally includes a pH modifier, which according to embodiments is present in an amount of 0 to 0.5 total weight percent. The pH modifier operative herein illustratively includes liquid sodium silicate, potassium carbonate, sodium carbonate, amino-2-hydroxyethane, 2-[bis(2- hydroxyethyl)amino]ethanol, 2-amino-2-methyl-1-propanol, soda ash, sodium hydroxide, lime, and a combination thereof. The pH modifier also acts as a soil-capturing agent.

An inventive vehicle exterior surface cleaning composition has a fully formulated viscosity of between 1 and 400 cSt, as measured at room temperature. In some inventive embodiments, a thickener is provided at afford better cling to non-horizontal surfaces and as a result, enhanced detergency and chelation reactivity. Thickeners operative herein illustratively include hydrophilic silicas; polysaccharides, such as xanthan gum, guar-guar, agar-agar, alginates and tyloses; water soluble celluloses such as carboxymethyl cellulose and hydroxyethyl cellulose; polyethylene glycol monoesters and diesters of fatty acids; polyacrylates; polyacrylamides; polyvinyl alcohols; and polyvinyl pyrrolidone; esters of fatty acids with polyols, such as pentaerythritol or trimethylol propane; and combinations thereof. A thickener is present in an inventive composition in an amount of 0 to 5.0 total weight percent. Viscosities are readily increased to values of from 50 to 5,000 Cst are readily achieved with inclusion of a thickener, as measured at standard temperature and pressure with a Brookfield viscometer.

A fragrance is readily added to the formulation. Exemplary fragrances are those of citrus, pine, floral, musk, or fruits. When present, a pH modifier, a fragrance is used in an amount of 0.1 to 1.0 total weight percent.

Typical vehicle exterior surface cleaning compositions according to the present invention are provided in Table 1.

TABLE 1
Inventive Vehicle exterior surface Cleaning
Compositions (amounts in total weight)

| | Typical Amount | Preferred Amount |
|---|---|---|
| Ingredient | Present (wt %) | Present (wt %) |
| Benzenediol | 1 to 40 | 3 to 25 |
| Surfactant(s) | 0.1 to 8.0 | 1 to 3.3 |
| Thioglycolate | 0 to 20 | 3 to 15 |
| Protectant | 0 to 5 | 1 to 3 |
| Dispersant | 0 to 5 | 1 to 3 |
| Solvent | 0 to 10 | 1 to 3 |
| Soil-capturing agent | 0 to 10 | 0.5 to 1.5 |
| Thickener | 0 to 5 | 1 to 3 |
| Fragrance | 0 to 1 | 0.1 to 0.2 |
| pH modifier | 0 to 5 | 0.01 to 0.5 |
| Secondary solvent | 0 to 10 | 1 to 5 |
| Water | Remainder up to 100% | Remainder up to 100% |

The method of cleaning the vehicle exterior surface may be by spraying on the aqueous cleaning composition and wiping off or rinsing off the aqueous cleaning composition with water and wiping to shine. The present exemplary embodiments are effective as, spray on, wipe off cleaner, which may effectively remove most of traffic/automotive soil contaminants from automobile tire wheel substrates such as alloy, aluminum, anodized, steel, paint and plastic trimmed wheels, preferably without harm to the various metallurgies/materials used in wheel production, as well as other vehicle exterior surface both interior and exterior to the vehicle. By cleaning regularly, wheels will retain their original finish and resist the iron induced damage, which can be caused by brake dust. The aqueous hard surface cleaning composition has a pH from 5 to 8. Thus, a vehicle exterior surface with iron containing debris thereon may be cleaned by applying the aqueous cleaning composition to the surface, removing at least a portion of the debris thereon.

A substrate may be cleaned with the aqueous cleaning composition by contacting the substrate with the aqueous cleaning composition for a period of time sufficient to remove substantial portion of the contaminants from the substrate, and is especially effective at removing iron containing debris. The aqueous cleaning composition may be applied in a sprayable liquid state onto the substrate and wets the grime adhered to the surface and allows removal thereof from the target surface. Upon this the cleaning composition with grime is wiped off or removed away by water. The present invention is further detailed with respect to the following nonlimiting examples that are provided to further illustrate the preparation of inventive compositions and certain attributes associated with the resulting coatings on vehicle exterior surfaces.

### EXAMPLES

The following compositions prove effective in vehicle exterior surface cleaning, even without resort to mechanical scrubbing.

### Example 1

A vehicle exterior surface cleaning composition is provided that includes: disodium catecholdisulfonate present at 15 total weight percent, a nonionic linear alcohol ethoxylate (LAE) (HLB 13_) present at 9.25 total weight percent (Alcohols, C9-11,ethoxalyted), a nonionic, ethylene oxide condensate with a cloud point of 50° C. (HLB 12.8) present at 4 total weight percent (1.5 to 1.8 branched tridecylalcohol, ethoxylated and 1.3 to 1.9 Isobutyl alcohol), a mixture of, orange terpenes, and sodium carbonate present at 7 total weight percent N,N-dimethyl 9-decenamide 0.2 to 1.5 and 0.2 to 0.6 total weight percent (d)-limonene, and. Water functions as a diluent that present as the remainder of the composition. The resulting composition upon contact with iron turns red in color and solubilizes the iron without a strong odor of hydrogen sulfide.

### Comparative Example

The composition of Example 1 is reproduced with the disodium catecholdisulfonate replaced with a like amount of water.

### Example 2

The composition of Example 1 is modified to include a water soluble dye present at 0.2 total weight percent and a citrus fragrance present at 0.05 total weight percent with a commensurate decrease in the amount of diluent present. The composition has vehicle exterior surface cleaning properties similar to Example 1.

### Example 3

The composition of Example 2 is modified to include colloidal silica present at 0.5 total weight percent that functions as a protectorant/thickener and diethylene glycol monobutyl ether present at 3 total weight percent and functions as a solvent with a commensurate decrease in the amount of diluent present. The composition has vehicle exterior surface cleaning properties similar to Example 1.

### Example 4

The composition of Example 3 is modified to include tetrasodium ethylenediamine tetraacetic acid present at 4 total weight percent and functions as a chelating agent and a pH adjustment agent present to adjust the pH to 6.5 with a commensurate decrease in the amount of diluent present. The composition has vehicle exterior surface cleaning properties similar to Example 1.

### Example 5

The composition of Example 1 is modified to include methoxydimethicone present at 3 total weight percent that functions as a protectant with a commensurate decrease in the amount of diluent present. The composition has vehicle exterior surface cleaning properties similar to Example 1.

### Examples 6 and 7

The composition of Example 1 is modified to replace disodium catecholdisulfonate with a like amount of either benzenetriols or coniferaldehyde. The composition has vehicle exterior surface cleaning properties similar to Example 1.

### Example 8

The composition of Example 1 is modified to include thioglycolate. The composition has vehicle exterior surface cleaning properties similar to Example 1.

### Example 9

The composition of Example 1 was tested and had no odor of sulfur. In a study, 2 grams of a brake dust formula is applied to each of two separate cold rolled steel panels and cured for 1 hour in a 50° C. oven. After cooling to 20° C., 2 grams of either conventional iron fallout product or the Example 1 formulation is applied separately to one of the two panels. Both formulas are retained in contact with a panel for 3 minutes. Once rinsed with water, the Example 1 formulation displayed stronger cleaning power as noted by a return to the panel appearance before brake dust application. In contrast, the conventional product remained stained and only resulted in a restored panel after agitation.

Patent documents and publications mentioned in the specification are indicative of the levels of those skilled in the art to which the invention pertains. These documents and publications are incorporated herein by reference to the same extent as if each individual document or publication was specifically and individually incorporated herein by reference

The foregoing description is illustrative of particular embodiments of the invention but is not meant to be a limitation upon the practice thereof. The following claims, including all equivalents thereof are intended to define the scope of the invention.

1. A vehicle exterior surface cleaning composition comprising:
at least one benzenediol operative herein has the general formula:
RO—(C₆H₂R¹R²)—OH
where R is H, or C₁-C₄ alkyl, C₁-C₄ alkyl alcohol, C₁-C₄ alkyl amine, C₁-C₄ alkyl carboxyl; and R¹ and R² are independently in each occurrence: H, OH, SO₃⁻, PO4³⁻, C₁-C₄ alkyl, C₁-C₄ alkyl alcohol, C₁-C₄ alkyl amine, C₁-C₄ alkyl carboxyl, C₂-C₈ alkyl or alkenyl ester, C₁-C₆ alkyl or alkenyl aldehyde, C₁-C₆ alkyl or alkenyl ketone, or;
at least one surfactant; an aqueous diluent making up a remainder of the composition.

2. The vehicle exterior surface cleaning composition of claim 1 the at least one benzenediol is present in an amount of 1 to 40 total weight percent.

3. The vehicle exterior surface cleaning composition of claim 1 wherein the at least one benzenediol is resorcinol, catechol, catecholdisulfonate, guaiacol, 4-methylcatechol, 1,2,4-benzenetriol, 1,2,3-benzenetriol, coniferaldehyde, or a combination thereof.

4. The vehicle exterior surface cleaning composition of claim 1 wherein the at least one benzenediol is catecholdisulfonate.

5. The vehicle exterior surface cleaning composition of claim 1 wherein the at least surfactant comprises a first non-ionic surfactant.

6. The vehicle exterior surface cleaning composition of claim 5 wherein the non-ionic surfactant has an HLB value of between 10 and 14.

7. The vehicle exterior surface cleaning composition of claim 6 further comprising a second non-ionic surfactant has an HLB value of between 0 and 20, the first non-ionic surfactant and the second non-ionic surfactant present at a molar ratio of 3-33:1.

8. The vehicle exterior surface cleaning composition of claim 1 further comprising a thioglycolate.

9. The vehicle exterior surface cleaning composition of claim 8 wherein the thioglycolate is present from 1 to 20 total weight percent.

10. The vehicle exterior surface cleaning composition of claim 4 wherein the dispersant is sodium polyacrylate.

11. The vehicle exterior surface cleaning composition of claim 1 further comprising a solvent present in an amount of 0 to 10 total weight percent.

12. The vehicle exterior surface cleaning composition of claim 1 further comprising a soil capturing agent present in an amount of 0 to 10 total weight percent.

13. The vehicle exterior surface cleaning composition of claim 12 wherein the soil capturing agent is ethylenediamine disuccinic acid (EDDS), ethylenediamine dimalonic acid (EDDM), and ethylenediamine diglutaric acid (EDDG), ethylenediaminetetraacetic acid (EDTA), diethylenetriaminepentaacetic acid (DTPA), nitrilotriacetic acid (NTA), iminodiacetic acid (IDA), iminotriacetic acid (ITA), ethylenediamine (En), N,N′-diethylenediamine (Den), diethylenetriamine (DTN), diethylenetetramine (Trien), triaminotriethylene amine, triethanolamine, malonic acid, succinic acid, glutaric acid, citric acid, fumaric acid, maleic acid, aconitic acid, hydroxyethylethylene diamine triacetic acid (HEDTA), or combinations thereof.

14. The vehicle exterior surface cleaning composition of claim 1 further comprising a pH modifier present in an amount of 1 to 5 total weight percent.

15. The vehicle exterior surface cleaning composition of claim 1 further comprising a protectant is a graphene, colloidal silica, a silane liquid at standard temperature and pressure, amodimethicone, methoxydimethicone, or a combination thereof.

16. A method of cleaning a vehicle exterior surface comprising:
applying the composition of claim 1 to a vehicle exterior surface; and
allowing a sufficient contact time for the composition on the vehicle exterior surface to loosen iron containing debris therefrom before removing the composition to clean the surface.

17. The method of claim 16 wherein the composition emits little to no odor of hydrogen sulfide or ammonia during the contact time.

18. The method of claim 16 wherein the iron containing debris changes color during the contact time.

19. The method of claim 16 wherein the contact time is 2 to 5 minutes at standard temperature and pressure.

20. The method of of claim 16 wherein the applying is by spraying or wiping.
